(19) United States
(12) Patent Application Publication
(10) Pub. No.: US 2005/0079902 A1
(43) Pub. Date: Apr. 14, 2005

(54) Positioning apparatus and method for a slide cover

(76) Inventors: Wei-Chih Chen, Chung Ho City (TW); Cheng-Cheng Wu, Chung Ho City (TW)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/680,298

(22) Filed: Oct. 8, 2003

(51) Int. Cl. H04M 1/00

(52) U.S. Cl. 455/575.4; 455/575.8; 455/575.1

(57) ABSTRACT

The positioning apparatus has a first magnetic component, a second magnetic component, and a third magnetic component. The first magnetic component and the second magnetic component are of a first magnetic polarity, and the third magnetic component is of a second magnetic polarity. The first magnetic component and the second magnetic component are configured together on a device body or a slide cover, and these two magnetic components are located at two different places along with a sliding direction of the slide cover. The third magnetic component is oppositely configured on the slide cover or the device body, which lacks the first and the second magnetic components.

### BACKGROUND OF THE INVENTION

1. Field of Invention

The present invention relates to a positioning apparatus. More particularly, the present invention relates to positioning apparatus and method for a slide cover of a portable electronic device.

2. Description of Related Art

Mobile telephones are portable and wireless telephone devices installed on conveyances, such as vehicles and ships, or carried by a user. Mobile telephones are different from extensions of the telephone or long distance radio transceivers. Mobile telephones provide users with the benefits of the same functions of and greater convenience than immobile telephones. Cooperating with international direct dialing, mobile telephone users can communicate with any other person in the world in an available range of a mobile telephone system.

In addition to a conventional leather case, a lift cover is designed on an outer casing of a mobile telephone to protect a keyboard panel or a display panel thereof, and another covering with a slide cover is further developed. The lift or slide cover prevents users from accidentally dialing due to mindless contact with the keyboard panel, as well as reducing damages caused by a direct hit to the mobile telephone.

FIG. 1A illustrates a schematic view of conventional mobile telephone with a slide cover. A mobile telephone 100 has a device body 102 and a slide cover 104. The device body 102 has a display device 108, such as a screen, and an input device 106, such as a keyboard. As illustrated in FIG. 1A, the slide cover 102 is opened, and the input device 106 not covered by the slide cover 102 is thus exposed for use. FIG. 1B illustrates a schematic view of the slide cover 104 when closed, and the input device 106 in FIG. 1A is covered by the slide cover 102, protecting the input device 106 from accidental contact as well as damaging blows.

FIG. 2A illustrates a schematic view of the device body 102 in FIG. 1A, and FIG. 2B illustrates a schematic rear view of the slide cover 104 in FIG. 1A. Two sliding trenches 112 are formed on two sides of the device body 102, and two sliding slices 114 are formed on two sides of the slide cover 104 and corresponding the sliding trenches 112. The sliding trenches 112 and the sliding slices 114 are slidingly connected to each other. The fixing positions of the slide cover 104, an open position or a closed position, are defined by a fin 122 on one end of the sliding trench 112 and an indentation 124 in the sliding slice 114, which are matched with each other to limit the movement of the slide cover 104.

When a user wants to use the mobile telephone 100 in FIG. 1, the user has to push or pull the slide cover 104 to open it and occasionally damages or opens incompletely the slide cover 104 because the force exerted by the user is excessive or insufficient. When the user wants to open the slide cover 104 but uses insufficient force, the user may lose an important call; when the user wants to close the slide cover 104 but uses insufficient force, the user cannot terminate a call.

In some news design of the slide cover, an elastic apparatus is attached to the slide cover to help the slide cover move. However, elastic fatigue of the elastic apparatus may be generated after frequent use, and the steps and components of fabricating the elastic apparatus and the slide cover are very minute and complicated. The slide cover having the elastic apparatus is therefore hard to fabricate, and moreover increases the difficulty of maintenance thereof.

### SUMMARY OF THE INVENTION

It is therefore an objective of the present invention to provide a positioning apparatus for a slide cover to improve the positioning and fixing of the slide cover. Several magnetic components of different or same magnetic polarity are separately configured on the slide cover and the device body to help the slide cover to move to and stay in a particular position.

It is another an objective of the present invention to provide an outer casing of a portable device, for which a slide cover thereof uses magnetic attraction to assist in moving to avoid the difficulty of fabrication and maintenance of the conventional slide cover with other assistant apparatus.

It is still another an objective of the present invention to provide a positioning method for a slide cover, which uses magnetic attraction to move the slide cover, to resolve the problems thereof, such as incomplete switching or easy damage by external force.

It is still another an objective of the present invention to provide a positioning apparatus for an extensible device having two plates. The relative positions of the two plates are attained by magnetic attraction to improve the positioning between the two plates.

In accordance with the foregoing and other objectives of the present invention, a positioning apparatus for a slide cover is described. The positioning apparatus has a first magnetic component and a second magnetic component, which are both of a first magnetic polarity, and a third magnetic component of a second magnetic polarity. The first magnetic component and the second magnetic component are configured together on the device body or the slide cover, and they are configured on two different places along the sliding direction of the slide cover. The third magnetic component is configured opposite the first magnetic component and the second magnetic component on the slide cover of the device body.

When a magnetic attraction between the first magnetic component and the third magnetic component is greater than a magnetic attraction between the second magnetic component and the third magnetic component, the slide cover moves to an open position. When the magnetic attraction between the first magnetic component and the third magnetic component is smaller than the magnetic attraction between the second magnetic component and the third magnetic component, the slide cover moves to a closed position.

In one preferred embodiment of the present invention, the first magnetic component, the second magnetic component and the first magnetic component are formed by inserting magnets into the device body and the slide cover, or coating or pasting magnet powder on the surfaces of the device body and the slide cover.

The invention further provides a first sliding component configured on the device body, and a second sliding component configured on the slide cover. The first sliding component and the second sliding component are slidingly connected to each other, so the slide cover is able to move between the open position and the closed position. In this preferred embodiment, the first sliding component includes two sliding trenches, which are separately formed in two sides of the device body, and the second sliding includes two sliding slices, which correspond to the two sliding trenches and are formed on two sides of the slide cover.

The slide cover includes two directions of movement; one direction of movement toward an open position is defined as a first direction, and the other direction of movement toward a closed position is defined as a second direction. In one aspect, when the first magnetic component and the second magnetic component are configured together on the device body, the third magnetic component is configured on the slide cover, and especially located on one end thereof extending along the first direction. The first magnetic component may be configured on one end of each sliding trench, and the second magnetic component may be configured on the other end of each sliding trench. Conversely, the first magnetic component may be configured on one end of the device body extending along the first direction, and the second magnetic component may be configured on the other end of the device body extending along the second direction.

In another aspect, when the first magnetic component and the second magnetic component are configured together on the slide cover, the third magnetic component is configured on the device body, and especially located on one end thereof extending along the second direction. The first magnetic component may be configured on one end of each sliding slice, and the second magnetic component may be configured on the other end of each sliding slice. Conversely, the first magnetic component may be configured on one end of the slide cover extending along the first direction, and the second magnetic component may be configured on the other end of the slide cover extending along the second direction.

In addition to the mobile telephone, the invention can also be applied in other portable devices having the slide covers, such as a personal digital assistant (PDA) or an electronic dictionary. Furthermore, the invention is provided for an extensible device having two plates, changes a relative position between the two plates by moving one plate thereof. In other words, the invention is not only limited to the portable device having the slide cover, but also can be used in the extensible device having two plates for improving the positioning between the two plates.

The positioning apparatus of the invention uses a combination of several magnetic components of different magnetic polarities to supplant the conventional combination of fins and indentation for moving and fixing the two plates in particular positions. The invention protects the positioning apparatus from bad fixing due to worn fins and indentations. Moreover, the invention helps move the plate with magnetic attraction. The structure and installation thereof are simple and easy and thus are better than those of the conventional apparatus, such as an elastic apparatus, whose combination is complicated and maintenance thereof is also very difficult.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1A illustrates a schematic view of conventional mobile telephone with a slide cover;

FIG. 1B illustrates a schematic view of the slide cover while closed;

FIG. 2A illustrates a schematic view of the device body in FIG. 1A;

FIG. 2B illustrates a schematic rear view of the slide cover in FIG. 1A;

FIG. 3A is a schematic view of the device body in the first preferred embodiment;

FIG. 3B is a schematic rear view of the slide cover in the first preferred embodiment;

FIG. 3C is a schematic view of the device body in the second preferred embodiment;

FIG. 3D is a schematic rear view of the slide cover in the second preferred embodiment;

FIG. 4A is a schematic view of the device body in the third preferred embodiment; and

FIG. 4B is a schematic rear view of the slide cover in the third preferred embodiment.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The First Preferred Embodiment:

In this embodiment, the first magnetic component is configured on one end of each sliding trench on the device body, the second magnetic component is configured on the other end of each sliding trench on the device body, and the third magnetic component is configured on one end of each sliding slice on the slide cover.

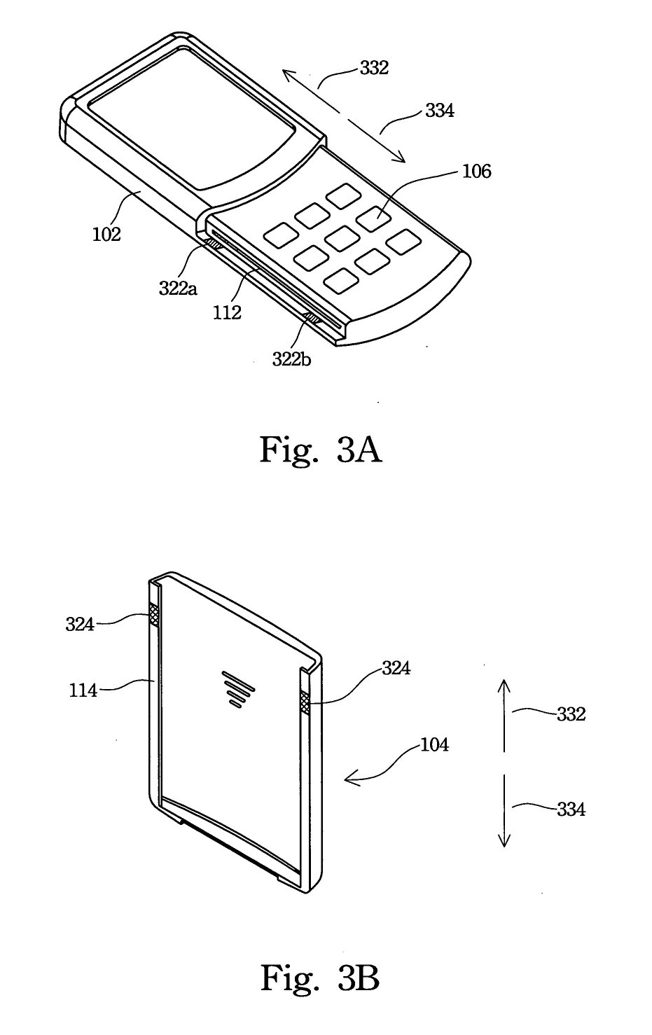

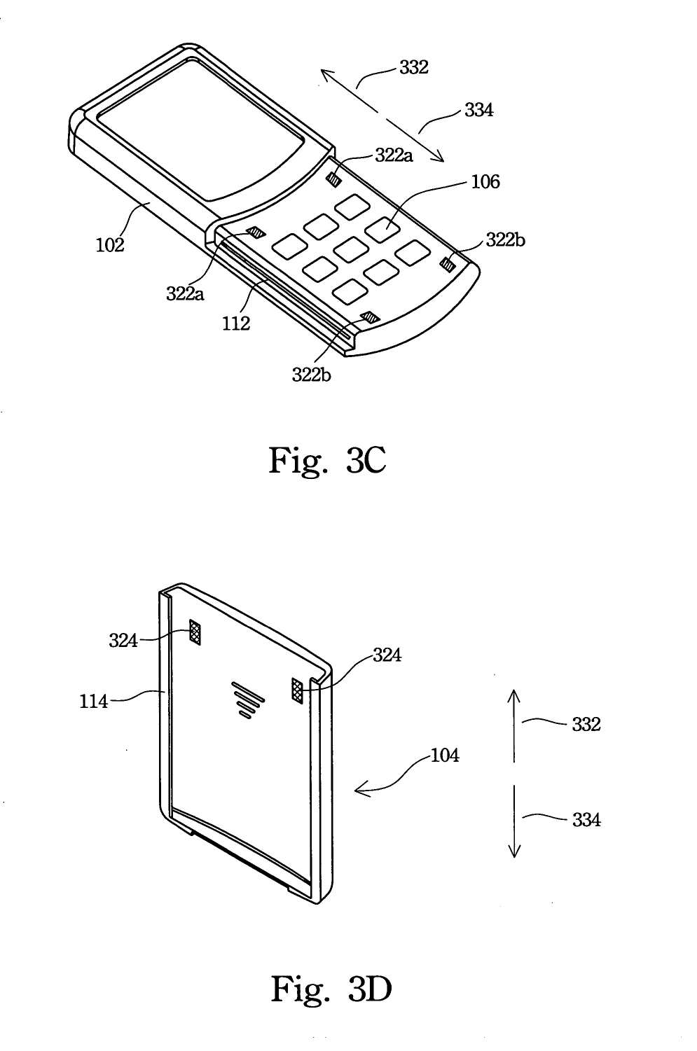

FIG. 3A is a schematic view of the device body in the embodiment, and FIG. 3B is a schematic rear view of the slide cover in the embodiment. As illustrated in FIG. 3A, the moving directions of the slide cover 104 are defined as: a first direction 332 toward an open position of the slide cover 104, and a second direction 334 toward a closed position. Each of the two sides of the device body 102 has a sliding trench 112, and the two ends of the sliding trench 112, one end extending along the first direction 332 and the other end extending along the second direction 334, have a first magnetic component 322a and a second magnetic component 322b, respectively. The magnetic force of the first magnetic component 322a is substantially equal to that of the second magnetic component 322b. As illustrated in FIG. 3B, each of the two sides of the slide cover 104 has a sliding slice 114 corresponding to the sliding trench 112, and two sides of the sliding slice 114 extending along the first direction 332 have two third magnetic components 324.

The positioning apparatus of the invention uses a combination of several magnetic components of different magnetic polarities to supplant the conventional combination of fins and indentations for moving and fixing the two plates in particular positions. The invention prevents the positioning apparatus from bad fixing due to worn fins and indentations. Therefore, in this embodiment, the first magnetic component 322a and the second magnetic component 322b are of the same magnetic polarity, and the third magnetic component 324 is of the other magnetic polarity. It is well known that two things of the same magnetic polarity repulse each other, and two things of different magnetic polarities attract each other.

The first magnetic component 322a, the second magnetic component 322b and the third magnetic component 324 of the embodiment are formed by inserting magnets into the device body 102 and the slide cover 104. According to another preferred embodiment, magnetic powder is coated or stuck on the surfaces of the device body 102 and the slide cover 104 to form the first magnetic component 322a, the second magnetic component 322b, and the third magnetic component 324, for example, adhesive papers with magnetic powder are adhered on the device body 102 and the slide cover 104. The invention helps the slide cover 104 move with the magnetic attraction. The structure and installation thereof are simply and easy, and thus are better than those of the conventional apparatus, such as an elastic apparatus, whose combination is complicated and maintenance thereof is also very difficult.

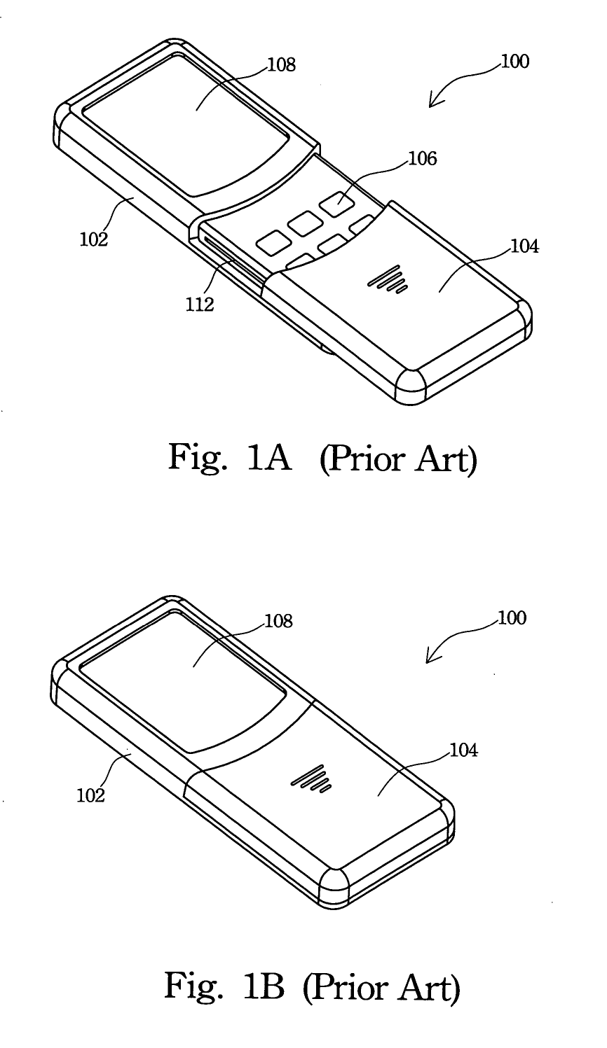

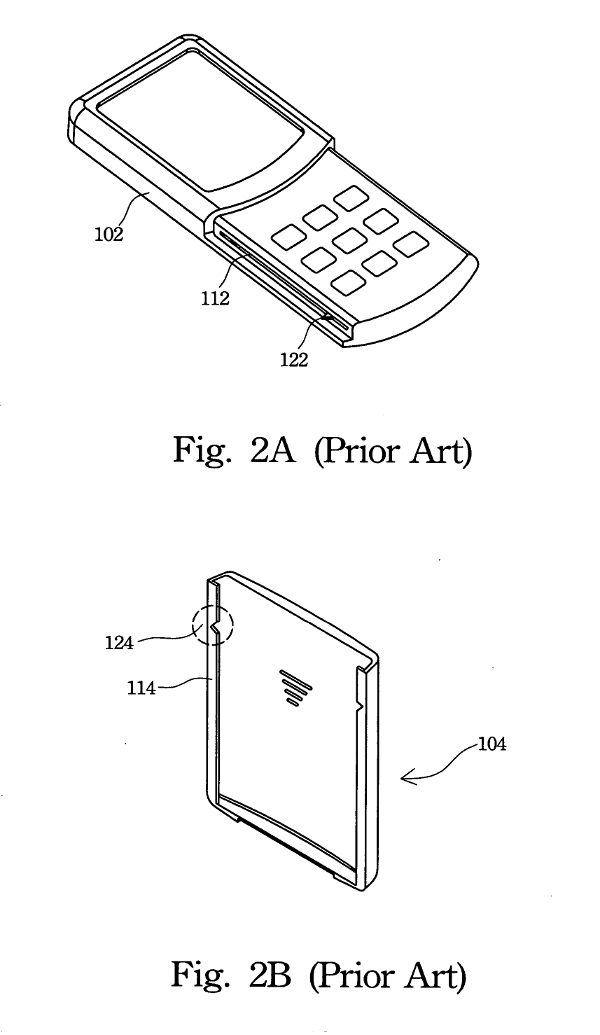

A sliding mechanism of the slide cover is formed by combining the device body 102 in FIG. 3A and the slide cover 104 in FIG. 3B. When the slide cover 104 is closed as illustrated in FIG. 1B, the first magnetic component 322a and the third magnetic component 324 are close to each other, and they are of different magnetic polarities, so the magnetic attraction between them is large enough to fix the slide cover 104 in the closed position for covering the input device 106.

When a user wants to open the closed slide cover 104, he has to apply a force to push the slide cover 104. The slide cover 104 then moves toward the second direction 334, and the relative position of the third magnetic component 324 also moves toward the second direction 334. When the position of the third magnetic component 324 exceeds the middle position between the first magnetic component 322a and the second magnetic component 322b, and is near to the second magnetic component 322b, a magnetic attraction between the second magnetic component 322b and the third magnetic component 324 is greater than a magnetic attraction between the first magnetic component 322a and the third magnetic component 324. The third magnetic component 324 therefore is accelerated to approach an open position, and then pushes the whole slide cover 104 to the open position. Finally, the slide cover 104 is fixed in the open position to expose the input device 106.

Similarly, when the user wants to close the opened slide cover 104, he also has to apply a force to push the slide cover 104. The slide cover 104 then moves in the first direction 332, and the relative position of the third magnetic component 324 also moves in the first direction 332. When the position of the third magnetic component 324 exceeds the middle position between the first magnetic component 322a and the second magnetic component 322b, and is near to the first magnetic component 322a, a magnetic attraction between the first magnetic component 322a and the third magnetic component 324 is greater than a magnetic attraction between the second magnetic component 322b and the third magnetic component 324. The third magnetic component 324 therefore is accelerated to approach a closed position, and then pushes the slide cover 104 to the closed position. Finally, the slide cover 104 is fixed in the closed position to cover the input device 106 again.

In addition, the two ends of the sliding trench 112 in this embodiment can be terminations for stopping the slide cover 104. The terminations prevent the slide cover 104 from accelerating and then oscillating between the upper positions of the first magnetic component 322a and the second magnetic component 322b by magnetic attraction.

The Second Preferred Embodiment:

In this embodiment, the first magnetic components are configured on one end adjacent to the input device on the device body, the second magnetic components are configured on the other end adjacent to the input device on the device body, and the third magnetic components are configured on one end of on the slide cover. This embodiment illustrates another configuration of the invention different from the first preferred embodiment.

FIG. 3C is a schematic view of the device body in the embodiment, and FIG. 3D is a schematic rear view of the slide cover in the embodiment. As illustrated in FIG. 3C, the moving directions of the slide cover 104 are defined as: a first direction 332 toward an open position of the slide cover 104, and a second direction is another direction which moves toward a closed position. Two ends of the device body 102, one end extending along the first direction 332 and the other end extending along the second direction 334, have first magnetic components 322a and second magnetic components 322b, respectively. As illustrated in FIG. 3D, one end of the inner surface of the slide cover 104 extending along the first direction 332 has two third magnetic components 324.

A sliding mechanism of the slide cover, similar to that of the first preferred embodiment, is formed by combining the device body 102 in FIG. 3C and the slide cover 104 in FIG. 3D. It is realized by the second preferred embodiment that the configured positions of the first magnetic component, the second magnetic component, and the third magnetic component in the invention can be modified by considering the mechanism designs thereof. In other words, the configured positions of the invention only need to conform to the spirit and scope of the invention, and are not limited by these embodiments as illustrated.

The Third Preferred Embodiment:

In this embodiment, the first magnetic component is configured on one end of each sliding slice on the slide cover, the second magnetic component is configured on the other end of each sliding slice on the slide cover, and the third magnetic component is configured on one end of each sliding trench on the device body. This embodiment illustrates still another configuration of the invention different from the first preferred embodiment.

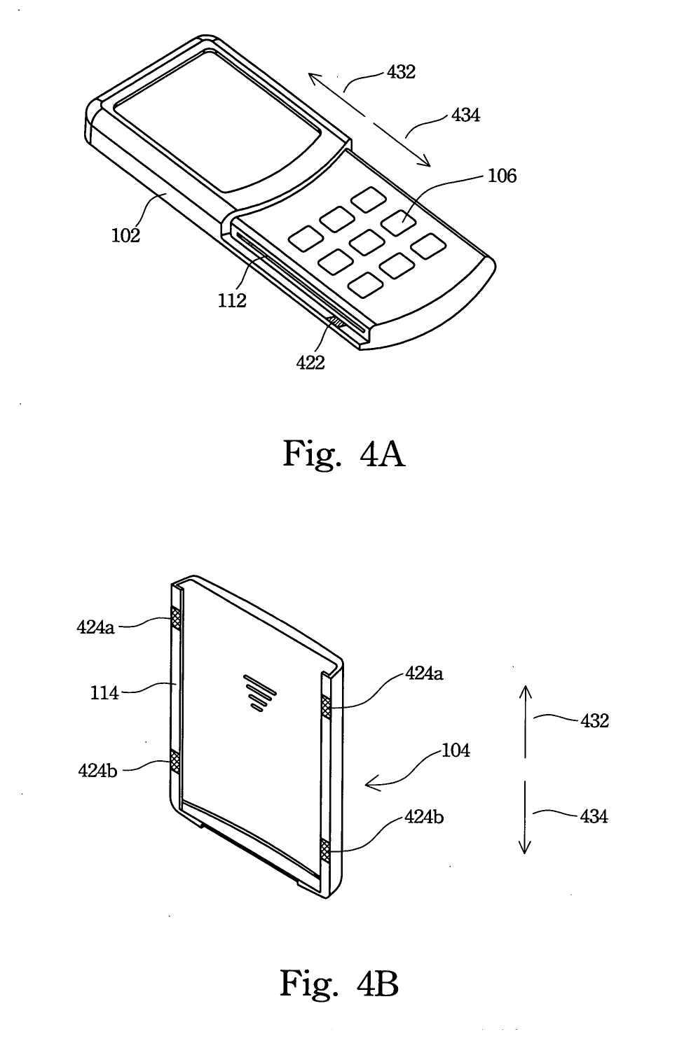

FIG. 4A is a schematic view of the device body in the embodiment, and FIG. 4B is a schematic rear view of the slide cover in the embodiment. As illustrated in FIG. 4A, the moving directions of the slide cover 104 are defined as: a first direction 432 toward an open position of the slide cover 104, and a second direction 434 toward a closed position. Each of the two sides of the device body 102 has a sliding trench 112, and the end of the sliding trench 112, extending along the first direction 432, has a third magnetic component 422. As illustrated in FIG. 4B, each of the two sides of the slide cover 104 has a sliding slice 114 corresponding to the sliding trench 112, and two ends of the sliding slice 114, one end extending along the first direction 432 and the other end extending along the first direction 434, have two first magnetic components 424a and second magnetic components 424b, respectively. The magnetic force of the first magnetic component 424a is substantially equal to that of the second magnetic component 424b.

A sliding mechanism of the slide cover is formed by combining the device body 102 in FIG. 4A and the slide cover 104 in FIG. 4B. When the slide cover 104 is closed as illustrated in FIG. 1B, the second magnetic component 424b and the third magnetic component 422 are close to each other, and they are of different magnetic polarities, so the magnetic attraction between them is large enough to fix the slide cover 104 in the closed position for covering the input device 106.

When a user wants to open the closed slide cover 104, he has to apply a force to push the slide cover 104. The slide cover 104 then moves in the second direction 434, and the relative positions of the first magnetic component 424a and the second magnetic component 424b also move in the second direction 434. When the position of the third magnetic component 422 exceeds the middle position between the first magnetic component 424a and the second magnetic component 424b, and is near the first magnetic component 424a, a magnetic attraction between the first magnetic component 424a and the third magnetic component 422 is greater than a magnetic attraction between the second magnetic component 424a and the third magnetic component 422. The first magnetic component 424a therefore is accelerated to approach an open position, and pushes the slide cover 104 to the open position. Finally, the slide cover 104 is fixed in the open position to expose the input device 106.

Similarly, when the user wants to close the open slide cover 104, he also has to apply a force to push the slide cover 104. The slide cover 104 then moves in the first direction 432, and the relative positions of the first magnetic component 424a and the second magnetic component 424b also move in the first direction 432. When the position of the third magnetic component 422 exceeds the middle position between the first magnetic component 424a and the second magnetic component 424b, and is near to the second magnetic component 424b, a magnetic attraction between the second magnetic component 424b and the third magnetic component 422 is greater than a magnetic attraction between the first magnetic component 424a and the third magnetic component 422. The third magnetic component 422 therefore is accelerated to approach a closed position, and then pushes the slide cover 104 to the closed position. Finally, the slide cover 104 is fixed in the closed position to cover the input device 106 again.

Thus the device body 102 in FIG. 4A and the slide cover 104 in FIG. 4B are combined as a sliding mechanism of the slide cover similar to that of the first preferred embodiment. Moreover, as in the second preferred embodiment, the third magnetic components 422 of the present embodiment also can be configured on one end on the device body 102, the first magnetic components 424a can be configured on one end on the slide cover 104, and the second magnetic components 424b can be configured on the other end on the slide cover 104.

In addition, the two ends of the sliding trench 112 in this embodiment can be terminations for stopping the slide cover 104. The terminations prevent the slide cover 104 from accelerating and then oscillating between the upper positions of the first magnetic component 424a and the second magnetic component 424b by the magnetic attractions.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A positioning apparatus for an extensible device, the extensible device having a first plate and a second plate, the positioning apparatus comprising:
at least one first magnetic component of a first magnetic polarity, configured on the first plate;
at least one second magnetic component of the first magnetic polarity, configured on the first plate; and
at least one third magnetic component of a second magnetic polarity, attracting the first magnetic polarity, and configured on the second plate;
wherein when a relative position between the first plate and the second plate is changed to make a magnetic attraction between the first magnetic component and the third magnetic component greater than a magnetic attraction between the second magnetic component and the third magnetic component, the second plate and the first plate moves relatively and is positioned in a first position, and wherein when the relative position between the first plate and the second plate is changed to make the magnetic attraction between the first magnetic component and the third magnetic component less than the magnetic attraction between the second magnetic component and the third magnetic component, the second plate and the first plate moves relatively and is positioned in a second position.

2. The positioning apparatus of claim 1, wherein the first plate is a device body, and the second plate is a slide cover.

3. The positioning apparatus of claim 1, wherein the first plate is a slide cover, and the second plate is a device body.

4. The positioning apparatus of claim 1, wherein the positioning apparatus further comprises a first sliding component and a second sliding component, the first sliding component is configured on the first plate, and the second sliding component is configured on the second plate, wherein the first sliding component is slidingly connected to the second sliding component.

5. The positioning apparatus of claim 4, wherein the first sliding component is a plurality of sliding trenches, formed on two sides of the first plate separately, and the second sliding component is a plurality of sliding slices, formed on two sides of the second plate corresponding the plurality of sliding trenches.

6. The positioning apparatus of claim 1, wherein a material of the first magnetic component, the second magnetic component and the third magnetic component is a magnet.

7. The positioning apparatus of claim 1, wherein a material of the first magnetic component, the second magnetic component and the third magnetic component is magnetic powder.

8. A positioning method for a slide cover of a portable electronic device, the portable electronic device having a device body and the slide cover, wherein the slide cover moves between a first position and a second position, the positioning method comprising:
forming a first magnetic attraction between the device body and the slide cover; and
forming a second magnetic attraction between the device body and the slide cover;
wherein when the slide cover is moved to make the first magnetic attraction greater than the second magnetic attraction, the slide cover moves to the first position, and when the slide cover is moved to make the first magnetic attraction less than the second magnetic attraction, the slide cover moves to the second position.

9. The positioning method of claim 8, wherein the step of forming the first magnetic attraction comprises:
providing a first magnetic component of a first magnetic polarity to be configured on the device body; and
providing a second magnetic component of a second magnetic polarity to be configured on the slide cover;
wherein the first magnetic polarity and the second magnetic polarity attract each other.

10. The positioning method of claim 8, wherein the step of forming the second magnetic attraction comprises:
providing a first magnetic component of a first magnetic polarity to be configured on the device body; and
providing a second magnetic component of a second magnetic polarity to be configured on the slide cover;
wherein the first magnetic polarity and the second magnetic polarity attract each other.
